(19) United States
(12) Patent Application Publication
(10) Pub. No.: US 2024/0381207 A1
(43) Pub. Date: Nov. 14, 2024

(54) METHOD AND USER EQUIPMENT TO ACTIVATE UNAVAILABILITY PERIOD DURING ACTIVE NON-ACCESS STRATUM (NAS) CONGESTION IN WIRELESS COMMUNICATION NETWORK

(71) Applicant: MediaTek Singapore Pte. Ltd., Singapore (SG)

(72) Inventors: Puneet, Bengaluru KA (IN); Marko Niemi, Oulu (FI)

(21) Appl. No.: 18/645,484

(22) Filed: Apr. 25, 2024

(30) Foreign Application Priority Data
May 9, 2023 (IN) 202321032828

(51) Int. Cl. H04W 36/22; H04W 60/04; H04W 60/06

(52) U.S. Cl. CPC H04W 36/22; H04W 60/04; H04W 60/06

(57) ABSTRACT

A method and a user equipment to activate an unavailability period during an active Non-Access Stratum (NAS) congestion in a wireless communication network are provided. The method includes: detecting that timer T3346 is running; and reporting, by user equipment (UE), an Unavailability information with a value of the unavailability period, while the timer T3346 is running or is deactivated.

This application claims the benefit of India Provisional application Ser. No. 202321032828, filed May 9, 2023, the disclosure of which is incorporated by reference herein in its entirety.

### TECHNICAL FIELD

The disclosure relates in general to a method and an electronic device, and more particularly to a method and a user equipment to activate an unavailability period during an active Non-Access Stratum (NAS) congestion in a wireless communication network.

### BACKGROUND

The “unavailability period” for a user equipment (UE) is used to execute required events like Silent modem reset, security patch updates, OS upgrades, MODEM SW upgrades, device reboot MODEM setting changes via OMA-DM, or the user equipment (UE) loses its satellite coverage for certain duration of time.

If the user equipment (UE) and the network support the unavailability period and an event is triggered in the user equipment (UE) or lose satellite coverage making the user equipment (UE) unavailable for a certain period of time, the user equipment (UE) shall activate the unavailability period and may store its 5GMM and 5GSM context in USIM or non-volatile memory to be able to reuse it after the unavailability period.

To activate the unavailability period, the user equipment (UE) provides an unavailability period duration during the registration procedure or during the de-registration procedure (see 3GPP TS 23.501 and 3GPP TS 23.502). The support for the unavailability period is negotiated in the registration procedure.

When the user equipment (UE) receives a cause #22 “Congestion” during registration procedure or service request procedure (5GS/N1 mode), then the user equipment (UE) stays on current camped cell and starts timer T3346 with a time period defined by 3GPP specification. While the timer T3346 is running, the user equipment (UE) is not allowed to initiate 5GMM registration procedure in 5GS.

There are some problems to be solved:

When Registration procedure for unavailability period activation is failed due to cause #22 congestion and the network assigns a timer T3346 value defined by 3GPP standards, it is undefined whether the user equipment (UE) should wait for unavailability period activation till the timer T3346 expiry or not.

When the timer T3346 is running, and an upper layer have requested unavailability period activation or the user equipment (UE) loses its satellite coverage for certain duration of time, then the user equipment (UE) is not allowed to trigger the registration procedure to activate unavailability period till the timer T3346 expiry. Then, it is undefined whether the user equipment (UE) should wait for unavailability period activation till the timer T3346 expiry or not.

### SUMMARY

The disclosure is directed to a method and a user equipment to activate an unavailability period during an active Non-Access Stratum (NAS) congestion in a wireless communication network.

According to one embodiment, a method to activate an unavailability period during an active Non-Access Stratum (NAS) congestion in a wireless communication network. The method includes: detecting that timer T3346 is running; and reporting, by user equipment (UE), an Unavailability information with a value of the unavailability period, while the timer T3346 is running or is deactivated.

According to another embodiment, a user equipment (UE) is provided. The user equipment (UE) includes a transceiver and a processor. The transceiver is configured to wirelessly communicate with a wireless network. The processor is coupled to the transceiver and configured to perform operations including: detecting that timer T3346 is running or is deactivated; and performing a MM procedure that needs to report an Unavailability information with a value of the unavailability period, while the timer T3346 is running or is deactivated.

According to another embodiment, an access and Mobility Management Function (AMF) is provided. The AMF is configured to perform: detecting 5GMM signalling congestion; performing a NAS level congestion control; rejecting 5GMM signalling requests from the user equipment (UE) as specified in 3GPP TS 23.501, under the 5GMM signalling congestion condition. The AMF accepts the following: requesting for mobility registration update when the user equipment (UE) is reporting unavailability information with a value of the unavailability period due to discontinuous coverage.

### BRIEF DESCRIPTION OF THE DRAWINGS

FIG. 1 illustrates an example network environment in which various solutions and schemes in accordance with the present disclosure may be implemented.

FIG. 2 illustrates a method to activate the unavailability period during an active Non-Access Stratum (NAS) congestion in the wireless communication network according to one embodiment.

FIG. 3 shows the Unavailability information element.

FIG. 4 illustrates the user equipment (UE) in accordance with an implementation of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

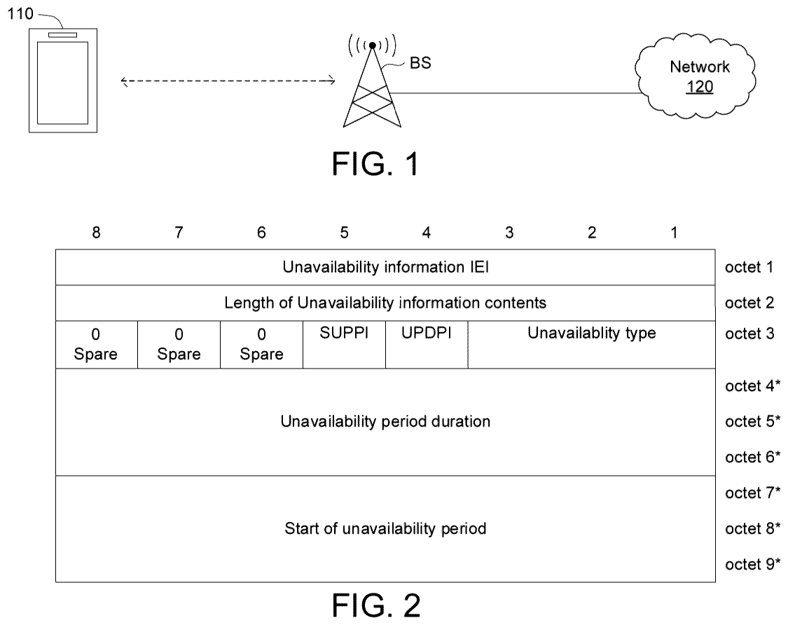

Please refer to FIG. 1, which illustrates an example network environment 100 in which various solutions and schemes in accordance with the present disclosure may be implemented. Referring to the FIG. 1, the network environment 100 may involve a user equipment (UE) 110 in wireless communication with a wireless network 120 (e.g., a 5G NR mobile network) as part of a communication network. The user equipment (UE) 110 may initially be in wireless communication with wireless network 120 via a base station BS or network node (e.g., an eNB, gNB or transmit-receive point (TRP)). In the network environment 100, the user equipment (UE) 110, the base station BS and the network 120 may implement various schemes pertaining to the user equipment (UE) behavior to activate an unavailability period during an active Non-Access Stratum (NAS) congestion in a wireless communication network, as described herein.

During Registration procedure, the user equipment (UE) 110 supporting the Unavailability Period feature provides “Unavailability Period Support” indication as part of 5GMM Core Network Capability in Registration Request message for initial registration and for every mobility registration update procedure. The Access and Mobility Management Function (AMF) indicates whether the corresponding feature is supported in the AMF by providing the “Unavailability Period Support” indication in Registration Accept message.

If the user equipment (UE) 110 and the network 120 support Unavailability Period and an event is triggered in the user equipment (UE) 110 that would make the user equipment (UE) 110 unavailable or lose coverage for a certain period of time, the user equipment (UE) 110 uses Support of Unavailability Period to inform the AMF of the expected unavailability and whether it is due to NR satellite access discontinuous coverage. Use of Support of Unavailability Period for loss of coverage due to NR satellite access discontinuous coverage shall only be used if both the user equipment (UE) 110 and the AMF signaled “Unavailable Period support”.

If the use of Support of Unavailability Period is not due to NR satellite access discontinuous coverage, the user equipment (UE) 110 may store its MM and SM context in the USIM or Non-Volatile memory in the ME to be able to reuse it after its unavailability period. If the user equipment (UE) 110 can store its contexts the user equipment (UE) 110 may trigger Mobility Registration Update procedure otherwise the user equipment (UE) 110 shall trigger UE-initiated Deregistration procedure.

Please refer to FIG. 2, which illustrates a method to activate the unavailability period during an active Non-Access Stratum (NAS) congestion in the wireless communication network according to one embodiment. To activate the unavailability period during the NAS congestion in the wireless communication network, the user equipment (UE) 110 is configured to perform the following steps S110 and S120.

In the step S110, the network 120 rejects a registration request triggered due to unavailability period activation with cause #22 or an upper-layer requests to activate unavailability period activation when the timer T3346 is running.

Then, in the step S120, at least one of the following operations is performed:
(1) The user equipment (UE) 110 performs a de-registration procedure to activate the unavailability period;
(2) The user equipment (UE) 110 informs to the upper layer that the unavailability period mode activation is failed due to the request is rejected for congestion or due to the timer T3346 is running;
(3) The user equipment (UE) 110 activates the unavailability period locally, and the user equipment (UE) 110 triggers a registration request for unavailability period activation (for the remaining unavailability time) when the timer T3346 expires or the user equipment (UE) 110 may just continue unavailability period until the period is over;
(4) The user equipment (UE) 110 is allowed to perform the registration procedure to activate the unavailability period even if the timer T3346 is running and the network 120 (AMF) accepts the request for the registration procedure to activate the unavailability period even if the timer T3346 is running or the NAS congestion is active.

Further, the present disclosure also provides a method for Handling of NAS level mobility management congestion control.

The AMF may detect 5GMM signalling congestion and perform general NAS level congestion control. Under the 5GMM signalling congestion conditions, the AMF may reject 5GMM signalling requests from UEs as specified in 3GPP TS 23.501. The AMF should not reject (accepts) the following:
a) requests for emergency services;
b) requests for emergency services fallback;
c) requests from UEs configured for high priority access in selected PLMN or SNPN;
d) DEREGISTRATION REQUEST message;
e) requests for mobile terminated services, triggered by paging or a notification procedure;
f) requests for initial registration or mobility and periodic registration update, when emergency is indicated by lower layers; and
g) requests for mobility registration update when the UE is reporting unavailability information due to discontinuous coverage.

Furthermore, if timer T3346 is running or is deactivated, and:
a) the UE is a UE configured for high priority access in selected PLMN or SNPN;
b) the UE needs to initiate signalling for emergency services or emergency services fallback; or
c) the UE needs to report unavailability information due to discontinuous coverage,
then the UE is allowed to initiate 5GMM procedures.

The purpose of the Unavailability information element is to provide the unavailability type, unavailability period duration and the start of unavailability period from the user equipment (UE) 110 to the network 120.

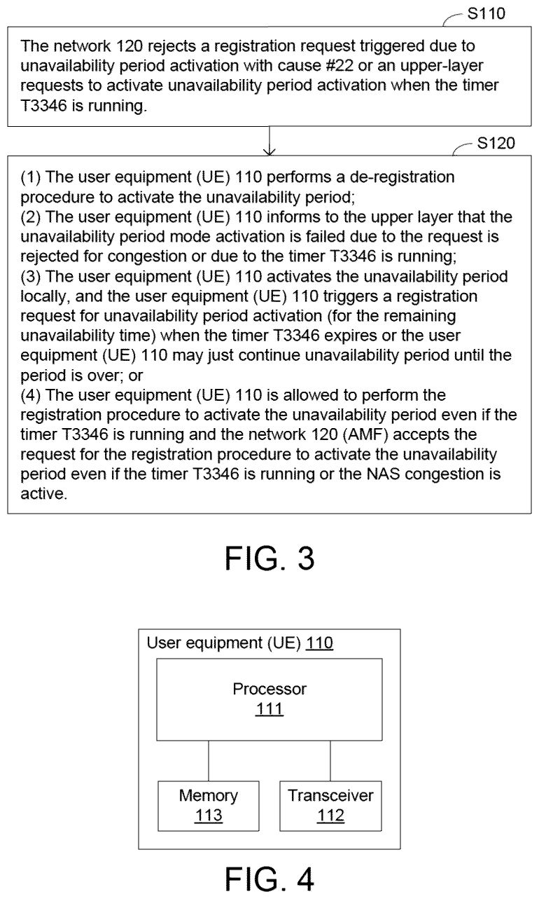

The Unavailability information element is coded as shown in the FIG. 3. The Unavailability information is a type 4 information element with a minimum length of 3 octets and maximum length of 9 octets.

To activate the unavailability period, the user equipment (UE) provides unavailability information, including a type of unavailability, an unavailability period duration if known, and the start of the unavailability period if known, during the registration procedure or during the de-registration procedure.

Please refer to FIG. 4, which illustrates the user equipment (UE) 110 in accordance with an implementation of the present disclosure. The user equipment 110 may perform various functions to implement schemes, techniques, processes and methods described herein pertaining to UE behavior in mobile communications, including the various schemes described above with respect to various proposed designs, concepts, schemes, systems and methods described above, including the network environment 100, as well as processes described below.

The user equipment (UE) 110 may be a part of an electronic apparatus, which may be a network apparatus, such as a portable or mobile apparatus, a wearable apparatus, a vehicular device or a vehicle, a wireless communication apparatus or a computing apparatus. For instance, the user equipment (UE) 110 may be implemented in a smartphone, a smart watch, a personal digital assistant, an electronic control unit (ECU) in a vehicle, a digital camera, or a computing equipment such as a tablet computer, a laptop computer or a notebook computer. The user equipment may also be a part of a machine type apparatus, which may be an IoT apparatus such as an immobile or a stationary apparatus, a home apparatus, a roadside unit (RSU), a wire communication apparatus or a computing apparatus. For instance, the user equipment (UE) may be implemented in a smart thermostat, a smart fridge, a smart door lock, a wireless speaker or a home control center. When implemented in or as a network apparatus, the user equipment (UE) 110 may be implemented in an eNodeB in an LTE, LTE-Advanced or LTE-Advanced Pro network or in a gNB or TRP in a 5G network, an NR network or an IoT network.

In some implementations, the user equipment (UE) 110 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, the user equipment (UE) 110 may be implemented in or as a network apparatus. The user equipment (UE) 110 may include at least some of those components shown in the FIG. 3, such as a processor 111, a transceiver 112 and a memory 113, for example. The user equipment (UE) 110 may further include one or more other components not pertinent to the proposed scheme of the present disclosure (e.g., internal power supply, display device and/or user interface device).

In one aspect, the processor 111 may be implemented in the form of one or more single-core processors, one or more multi-core processors, or one or more CISC or RISC processors. That is, even though a singular term “a processor” is used herein to refer to the processor 111, the processor 111 may include multiple processors in some implementations and a single processor in other implementations in accordance with the present disclosure. In another aspect, the processor 111 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, the processor is a special-purpose machine specifically designed, arranged and configured to perform specific tasks including those pertaining to the user equipment (UE) 110 behavior for failed registration and service requests for emergency services fallback in mobile communications in accordance with various implementations of the present disclosure.

The transceiver 112 is coupled to the processor 111. The transceiver 112 may be capable of wirelessly transmitting and receiving data. In some implementations, the transceiver 112 may be capable of wirelessly communicating with different types of wireless networks of different radio access technologies (RATs). In some implementations, the transceiver 112 may be equipped with a plurality of antenna ports (not shown) such as, for example, four antenna ports. That is, the transceiver 112 may be equipped with multiple transmit antennas and multiple receive antennas for multiple-input multiple-output (MIMO) wireless communications.

The memory 113 is coupled to the processor 111 and stores data therein. The memory 113 may include a type of random-access memory (RAM) such as dynamic RAM (DRAM), static RAM (SRAM), thyristor RAM (T-RAM) and/or zero-capacitor RAM (Z-RAM). Alternatively, or additionally, the memory 113 may include a type of read-only memory (ROM) such as mask ROM, programmable ROM (PROM), erasable programmable ROM (EPROM) and/or electrically erasable programmable ROM (EEPROM). Alternatively, or additionally, the memory 113 may include a type of non-volatile random-access memory (NVRAM) such as flash memory, solid-state memory, ferroelectric RAM (FeRAM), magnetoresistive RAM (MRAM) and/or phase-change memory.

The processor 111 of the user equipment (UE) 110, is configured to perform operations described as above.

According to the disclosure described as above, the user equipment (UE) behavior is clear defined to activate the unavailability period during the active Non-Access Stratum (NAS) congestion in the wireless communication network.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method to initiate an MM procedure to activate an unavailability period during an active Non-Access Stratum (NAS) congestion in a wireless communication network, comprising:
detecting that timer T3346 is running or is deactivated; and
reporting, by user equipment (UE), an Unavailability information with a value of the unavailability period, while the timer T3346 is running or is deactivated.

2. The method according to claim 1, wherein the unavailability information is consisting of a value or duration of the unavailability period due to a discontinuous coverage.

3. The method according to claim 2, wherein the unavailability information is consisting of one or more of an unavailability type, an unavailability period duration and a start of unavailability period.

4. The method according to claim 1, wherein the unavailability information is provided to activate the unavailability period by an upper-layer requests or by the user equipment (UE) determining loss of satellite coverage when the timer T3346 is running or is deactivated.

5. The method according to claim 1, wherein a network rejects the MM procedure to activate the unavailability period activation with cause #22.

6. The method according to claim 1, wherein a network accepts the MM procedure to activate unavailability.

7. The method according to claim 1, wherein in the MM procedure, the UE performs a registration request procedure and the network either rejects or accepts procedure to activate the unavailability period when the NAS congestion is active.

8. The method according to claim 1, wherein the user equipment (UE) activates the unavailability period locally, and the user equipment triggers a registration request for unavailability period activation when the timer T3346 expires.

9. The method according to claim 1, wherein the user equipment continues the unavailability period until the unavailability period is over.

10. The method according to claim 1, wherein in the MM procedure, the UE performs a de-registration procedure to activate unavailability period.

11. The method according to claim 1, wherein the user equipment (UE) informs to an upper layer that unavailability period activation is failed due to a request is rejected for congestion or due to the timer T3346 is running.

12. A user equipment (UE), comprising:
a transceiver, configured to wirelessly communicate with a wireless network;
a processor, coupled to the transceiver and configured to perform operations comprising:
detecting that timer T3346 is running or is deactivated; and
performing a MM procedure that needs to report an Unavailability information with a value of the unavailability period, while the timer T3346 is running or is deactivated.

13. The user equipment (UE) according to claim 12, wherein the unavailability information is consisting of a value or duration of the unavailability period due to a discontinuous coverage.

14. The user equipment (UE) according to claim 13, wherein the unavailability information is consisting of one or more of an unavailability type, an unavailability period duration and a start of unavailability period.

15. The user equipment (UE) according to claim 12, wherein the unavailability information is provided to activate the unavailability period by an upper-layer requests or by the user equipment (UE) determining loss of satellite coverage when the timer T3346 is running or is deactivated.

16. The user equipment (UE) according to claim 12, wherein a network rejects the MM procedure to activate the unavailability period activation with cause #22.

17. The user equipment (UE) according to claim 12, wherein a network accepts the MM procedure to activate unavailability.

18. The user equipment (UE) according to claim 12, wherein the user equipment (UE) activates the unavailability period locally, and the user equipment (UE) triggers a registration request for unavailability period activation when the timer T3346 expires.

19. The user equipment (UE) according to claim 12, wherein the user equipment continues the unavailability period until the unavailability period is over.

20. An access and Mobility Management Function (AMF), wherein the AMF is configured to perform:
detecting 5GMM signalling congestion;
performing a NAS level congestion control; and
rejecting 5GMM signalling requests from the user equipment (UE) as specified in 3GPP TS 23.501, under the 5GMM signalling congestion condition;
wherein the AMF accepts the following:
requesting for mobility registration update when the user equipment (UE) is reporting unavailability information with a value of the unavailability period due to discontinuous coverage.
